(19) United States
(12) Patent Application Publication
(10) Pub. No.: US 2021/0042424 A1
(43) Pub. Date: Feb. 11, 2021

(54) SYSTEM AND METHOD FOR MISAPPROPRIATION DETECTION AND MITIGATION USING GAME THEORETICAL EVENT SEQUENCE ANALYSIS

(71) Applicant: BANK OF AMERICA CORPORATION, Charlotte, NC (US)

(72) Inventor: Eren Kursun, New York, NY (US)

(73) Assignee: BANK OF AMERICA CORPORATION, Charlotte, NC (US)

(21) Appl. No.: 16/536,853

(22) Filed: Aug. 9, 2019

(51) Int. Cl. G06F 21/60; G06N 3/04; G06N 3/08; A63F 13/73

(52) U.S. Cl. CPC G06F 21/60; G06N 3/04; G06F 21/6245; A63F 13/73; G06N 3/08

(57) ABSTRACT

A system is typically configured for extracting interaction data from one or more data sources, analyzing the interaction data to identify one or more exposure event sequences, storing the one or more exposure event sequences in look-up libraries, modelling a game by mapping one or more interactions associated with the interaction data, continuously monitoring real-time interaction streams, identifying at least one real-time interaction request based on continuously monitoring the real-time interaction streams, mapping the at least one real-time interaction request onto the game, and playing the game, via a neural network, to generate an output associated with the at least one real-time interaction request.

### BACKGROUND

Current conventional systems do not have the capability to prevent misappropriation of information that is exchanged in interactions between an entity and users. As such, there exists a need for a system to prevent misappropriation of the information exchanged during interactions.

### BRIEF SUMMARY

Embodiments of the present invention address the above needs and/or achieve other advantages by providing apparatuses (e.g., a system, computer program product and/or other devices) and methods for preventing misappropriation of data exchanged in interactions between users and entities. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may extract interaction data from one or more data sources, analyze the interaction data to identify one or more exposure event sequences, store the one or more exposure event sequences in look-up libraries, model a game by mapping one or more interactions associated with the interaction data, continuously monitor real-time interaction streams, identify at least one real-time interaction request based on continuously monitoring the real-time interaction streams, map the at least one real-time interaction request onto the game, and play the game, via a neural network, to generate an output associated with the at least one real-time interaction request.

In some embodiments, the system models the game based on mapping one or more states associated with the one or more interactions, mapping one or more state transitions associated with the one or more interactions, and mapping one or more exposures associated with each of the one or more states.

In some embodiments, the system prunes the one or more exposure event sequences and updates the look-up libraries with the pruned one or more exposure event sequences.

In some embodiments, the system inputs the pruned one or more exposure event sequences to the neural network and causes the neural network to train itself via reinforcement learning, wherein the neural network trains itself based on playing the game against itself as an unauthorized user.

In some embodiments, the system dynamically prunes the pruned one or more exposure event sequences based on real-time interaction data that is extracted from the real-time interaction streams and updates the look-up libraries with the dynamically pruned one or more exposure event sequences, wherein the dynamically pruned one or more exposure event sequences used by the neural network to train itself.

In some embodiments, the system plays the game to generate the output by identifying one or more possible paths associated with the at least one real-time interaction and determining one or more possible outcomes for each of the one or more possible paths associated with the at least one real-time interaction.

In some embodiments, the system generates the output based on balancing unauthorized user gain and authorized user denials.

In some embodiments, the system generates the output based on one or more policies associated with an entity.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for preventing misappropriation of information exchanged between an entity and users during interactions, in accordance with an embodiment of the invention;

FIG. 2 provides a block diagram illustrating the entity system 200 of FIG. 1, in accordance with an embodiment of the invention;

FIG. 3 provides a block diagram illustrating an event sequence analysis system 300 of FIG. 1, in accordance with an embodiment of the invention;

FIG. 4 provides a block diagram illustrating the computing device system 400 of FIG. 1, in accordance with an embodiment of the invention;

FIG. 5 provides a flowchart illustrating a process flow for preventing misappropriation of information exchanged between an entity and users during interactions, in accordance with an embodiment of the invention;

FIG. 6 provides a block diagram illustrating a 3 play game tree example for illustrating all possible outcomes associated with event sequences, in accordance with an embodiment of the invention;

FIG. 7 provides a block diagram illustrating one or more steps performed by the system to prevent misappropriation of information exchanged between the entity and the users during interactions, in accordance with an embodiment of the invention; and

FIG. 8 provides a block diagram illustrating the functions of the event sequence analysis system 300 of FIG. 1, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “entity” or “resource entity” may include any organization that processes financial transactions including, but not limited to, banks, credit unions, savings and loan associations, investment companies, stock brokerages, asset management firms, insurance companies and the like. Furthermore, embodiments of the present invention use the term “user” or “customer.” It will be appreciated by someone with ordinary skill in the art that the user or customer may be a customer of the financial institution.

In the instances where the entity is a financial institution, a customer may be an individual or organization with one or more relationships affiliations or accounts with the entity. An “account” may be the relationship that the customer has with the entity. Examples of accounts include a deposit account, such as a transactional account (e.g. a banking account), a savings account, an investment account, a money market account, a time deposit, a demand deposit, a pre-paid account, a credit account, a non-monetary customer profile that includes only personal information associated with the customer, or the like. An account may be associated with and/or maintained by an entity.

As used herein, the term “event” may be an interaction between the entity and users of the entity. In some embodiments, the event may be an exposure event. As used herein, the term “exposure event” may be any unauthorized event which may include misappropriation of information, account take over, draining of funds in accounts of a user, changing user access information, or the like. As used herein, the “interaction” may be any kind of interaction with a user or a system of an entity. The interaction, may include, but not limited to, an interaction with an Interactive Voice Response (IVR) system, an interaction with an employee of an entity (e.g., a call center associate, bank teller, or the like).

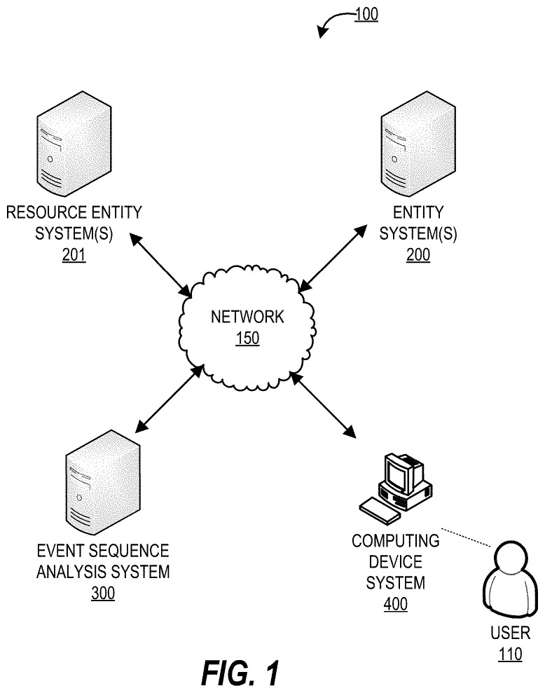

FIG. 1 provides a block diagram illustrating a system environment 100 for preventing misappropriation of information exchanged between an entity and users during interactions, in accordance with an embodiment of the invention. As illustrated in FIG. 1, the environment 100 includes an event sequence analysis system 300, entity system 200, a computing device system 400, and one or more resource entity systems 201. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200.

The entity system(s) 200 may be any system owned or otherwise controlled by an entity to support or perform one or more process steps described herein. In some embodiments, the managing entity is a financial institution.

The event sequence analysis system 300 is a system of the present invention for performing one or more process steps described herein. In some embodiments, the event sequence analysis system 300 may be an independent system. In some embodiments, the event sequence analysis system 300 may be a part of the entity system 200.

The event sequence analysis system 300, the entity system 200, the computing device system 400, and/or the resource entity systems 201 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the event sequence analysis system 300 is configured to communicate information or instructions with the entity system 200, the computing device system 400, and/or the resource entity systems 201 across the network 150.

The computing device system 400 may be a computing device of the user 11. In general, the computing device system 400 communicates with the user 110 via a user interface of the computing device system 400, and in turn is configured to communicate information or instructions with the event sequence analysis system 300, entity system 200, and/or the resource entity systems 201 across the network 150.

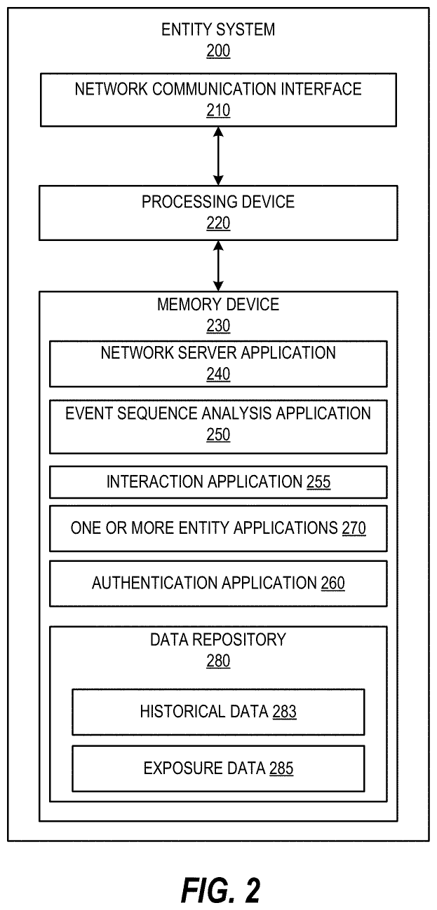

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, an event sequence analysis application 250, an interaction application 255, one or more entity applications 270, an authentication application 260, and a data repository 280 comprises user data 283 and exposure data 285. The computer-executable program code of the network server application 240, the event sequence analysis application 250, the interaction application 255, the one or more entity applications 270, and the authentication application 260 to perform certain logic, data-extraction, and data-storing functions of the entity system 200 described herein, as well as communication functions of the entity system 200.

The network server application 240, the event sequence analysis application 250, the interaction application 255, the one or more entity applications 270, and the authentication application 260 are configured to store data in the data repository 280 or to use the data stored in the data repository 280 when communicating through the network communication interface 210 with the event sequence analysis system 300, the computing device system 400, and/or the resource entity systems 201 to perform one or more process steps described herein. In some embodiments, the entity system 200 may receive instructions from the event sequence analysis system 300 via the event sequence analysis application 250 to perform certain operations. The event sequence analysis application 250 may be provided by the event sequence analysis system 300. The interaction application 255 may be any application used by the entity system to communicate with one or more users 110. In an exemplary embodiment, the interaction application 255 may be an Interactive Voice Response (IVR) application. The one or more entity applications 270 may be any of the applications used, created, modified, and/or managed by the entity system 200. The authentication application 260 may be used to authenticate one or more users 110 to access the one or more entity applications 270. In one embodiment, the entity application may be an online banking application provided by the entity system 200.

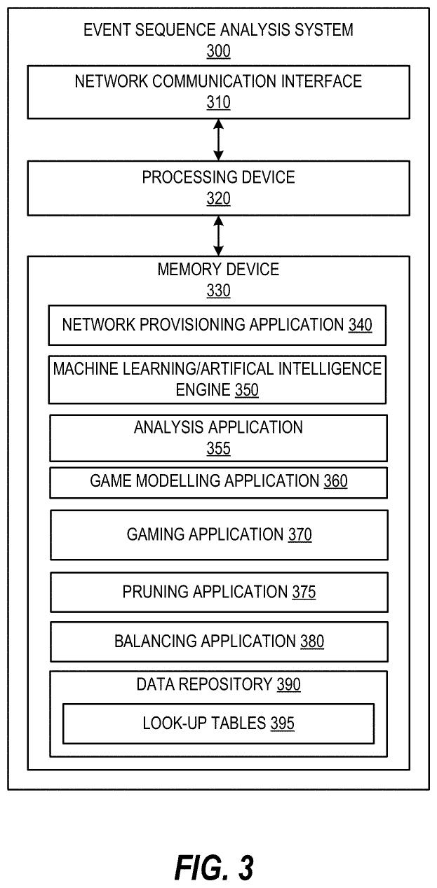

FIG. 3 provides a block diagram illustrating the event sequence analysis system 300 in greater detail, in accordance with embodiments of the invention. As illustrated in FIG. 3, in one embodiment of the invention, the event sequence analysis system 300 includes one or more processing devices 320 operatively coupled to a network communication interface 310 and a memory device 330. In certain embodiments, the event sequence analysis system 300 is operated by a first entity, such as a financial institution, while in other embodiments, the event sequence analysis system 300 is operated by an entity other than a financial institution. In some embodiments, the event sequence analysis system 300 is owned or operated by the entity of the entity system 200. In some embodiments, the event sequence analysis system 300 may be an independent system. In alternate embodiments, the event sequence analysis system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the event sequence analysis system 300 described herein. For example, in one embodiment of the event sequence analysis system 300, the memory device 330 includes, but is not limited to, a network provisioning application 340, a machine learning/artificial intelligence engine 350, an analysis application 355, a game modelling application 360, a gaming application, a pruning application 375, a balancing application 380, and a data repository 390 comprising data processed or accessed by one or more applications in the memory device 330. The computer-executable program code of the network provisioning application 340, the machine learning/artificial intelligence engine 350, the analysis application 355, the game modelling application 360, the gaming application 370, the pruning application 375, and the balancing application 380 may instruct the processing device 320 to perform certain logic, data-processing, and data-storing functions of the event sequence analysis system 300 described herein, as well as communication functions of the event sequence analysis system 300.

The network provisioning application 340, the machine learning/artificial intelligence engine 350, the analysis application 355, the game modelling application 360, the gaming application 370, the pruning application 375, and the balancing application 380 are configured to invoke or use the data in the data repository 390 when communicating through the network communication interface 310 with the entity system 200, the computing device system 400, and/or the resource entity systems 201. In some embodiments, the network provisioning application 340, the machine learning/artificial intelligence engine 350, the analysis application 355, the game modelling application 360, the gaming application 370, the pruning application 375, and the balancing application 380 may store the data extracted or received from the entity system 200, the resource entity system 201, and the computing device system 400 in the data repository 390. In some embodiments, the network provisioning application 340, the machine learning/artificial intelligence engine 350, the analysis application 355, the game modelling application 360, the gaming application 370, the pruning application 375, and the balancing application 380 may be a part of a single application. One or more processes performed by the network provisioning application 340, the machine learning/artificial intelligence engine 350, the analysis application 355, the game modelling application 360, the gaming application 370, the pruning application 375, and the balancing application 380 are described in detail below.

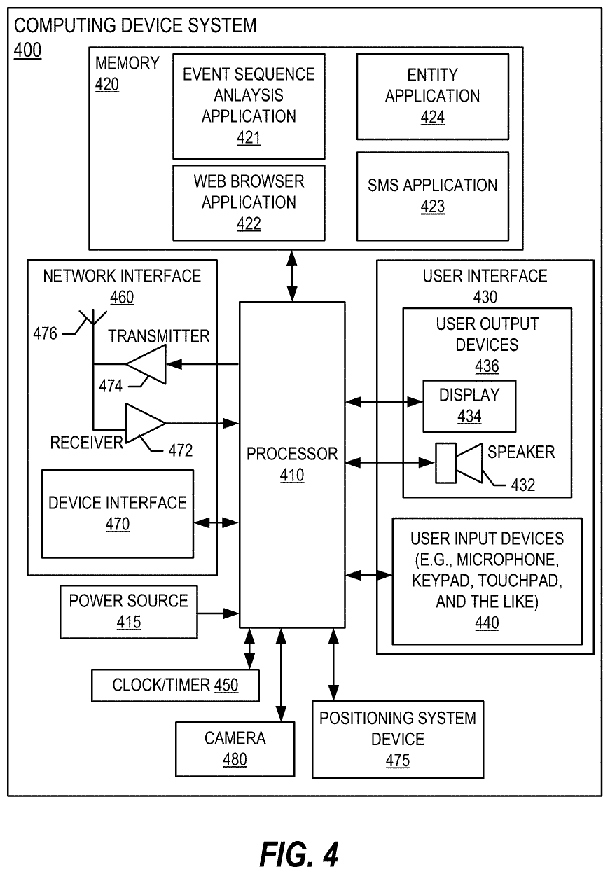

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110 may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, an event sequence analysis application 421, an entity application 424, or the like. These applications also typically instructions to a graphical user interface (GUI) on the display 430 that allows the user 110 to interact with the entity system 200, the event sequence analysis system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the event sequence analysis application 421 provided by the event sequence analysis system 300 allows the user 110 to communicate with one or more resource entity systems 201 anonymously. In some embodiments, the entity application 424 provided by the entity system 200 and the event sequence analysis application 421 allow the user 110 to perform one or more interactions. In some embodiments, the entity application 424 may be an online banking application. In some embodiments, the event sequence analysis system 300 monitors user activity via the entity application 424, the web browser application 422, and other application stored in the memory 420.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

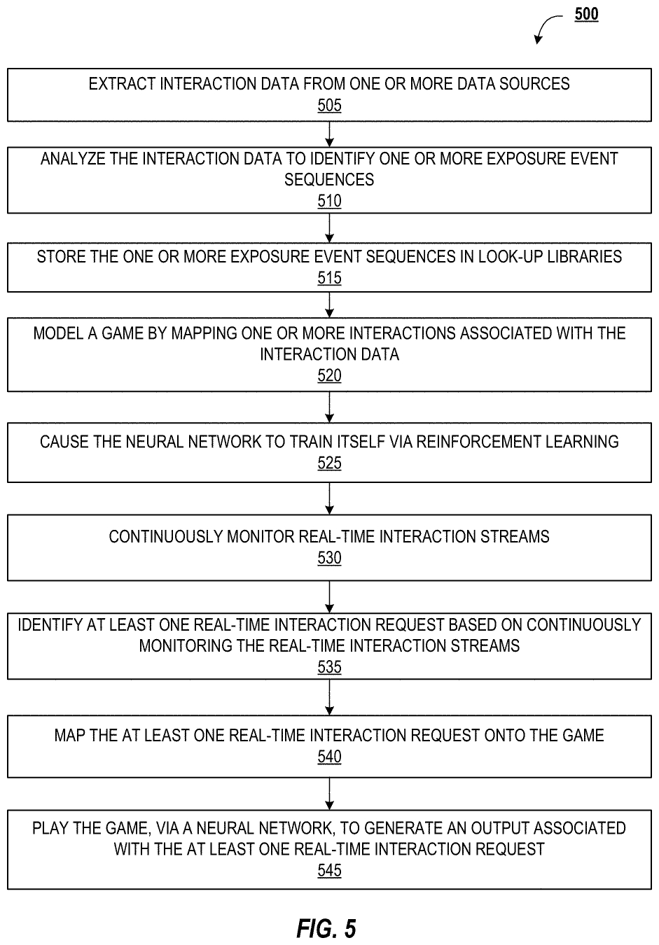

FIG. 5 illustrates a process flow 500 for preventing misappropriation of information exchanged between an entity and users during interactions, in accordance with an embodiment of the present invention. Information including personal information, account related information, or the like may be exchanged between users and an entity in multiple interactions. However, the users interacting with the entity may be authorized users or unauthorized users. In an exemplary embodiment, the unauthorized user may interact with an entity system such as an IVR system and obtain information related to an authorized user. Over a period of time, the unauthorized user may enter into multiple interactions with the entity system and gather information associated with the authorized user and may use that information to perform an event, where the event may be changing the login credentials of an account of the authorized user. It is difficult to identify whether an individual interacting with the entity system is an authorized user or an unauthorized user. The system of the present invention prevents the misappropriation of information exchanged between users and the entity in multiple interactions as explained in detail below.

As shown in block 505, the system extracts interaction data from one or more data sources. The interaction data may include monetary and non-monetary interaction data such as transaction data, appointment related data, IVR interaction data, exposure data, or the like. The one or more data sources may include entity system or any other third party systems.

As shown in block 510, the system analyzes the interaction data to identify one or more exposure event sequences. The system analyzes the interaction data to identify event sequences that are associated with one or more exposures. The system may identify one or more event sequences that led to an exposure event. For example, the system may identify that an unauthorized user tried logging into an authorized user's account by interacting with an entity system (e.g., online banking) in a first interaction, interacted with an IVR system to gain information associated with the accounts of the user in a second interaction, an employee of the entity to gain information associated with the resources in the accounts of the user in an ‘n^{th}’ interaction, or the like. The system may identify that these event sequences eventually caused the unauthorized user to drain the resources in the accounts of the user using the information extracted from the first interaction to the ‘n^{th}’ interaction. As shown in block 515, the system stores the one or more exposure event sequences in look-up libraries.

In some embodiments, the system prunes the one or more event sequences and updates the look-up libraries. For example, the system automatically prunes the one or more exposure event sequences by identifying and deleting duplicate or known event sequences. Based on pruning the one or more exposure event sequences, the process of extracting and identifying exposure event sequences in real-time becomes efficient. In some embodiments, the system may prune the one or more event sequences based on real-time data. In some embodiments, the system may identify a new exposure event and may add the event sequences associated with the exposure event to the look-up library. In such embodiments, the system may dynamically prune the one or more exposure event sequences in the look-up library. For example, the system may identify that the event sequences associated with the new exposure event align with a party of the existing one or more exposure event sequences in the look-up library and may dynamically prune the event sequences associated with the new exposure event and may combine event sequences with the existing one or more exposure event sequences.

In some embodiments, the system feeds the one or more event sequences and the interaction data into a neural network. As shown in block 520, the system models a game by mapping one or more interactions associated with the interaction data. As shown in block 525, the system causes the neural network to train itself via reinforcement learning. The neural network trains itself by playing the game against itself utilizing the one or more event sequences and the interaction data.

As shown in block 530, the system continuously monitors real-time interaction streams. In an exemplary embodiment, the system may tap into the IVR system associated with an entity. In another exemplary embodiment, the system may establish a communication link with a user computing device of an employee of the entity.

As shown in block 535, the system identifies at least one real-time interaction request based on continuously monitoring the real-time interaction streams. For example, the system may identify an interaction initiated by a user with the IVR system, where the user may be an authorized user or an unauthorized user.

As shown in block 540, the system maps the at least one real-time interaction request onto the game. The system connects the at least one real-time interactions with the other interactions that are associated with the at least one real-time interactions. For example, the system may identify that the at least one real-time interaction is associated with a first account, the system maps the at least one real-time interaction with other interactions that are associated with the first account.

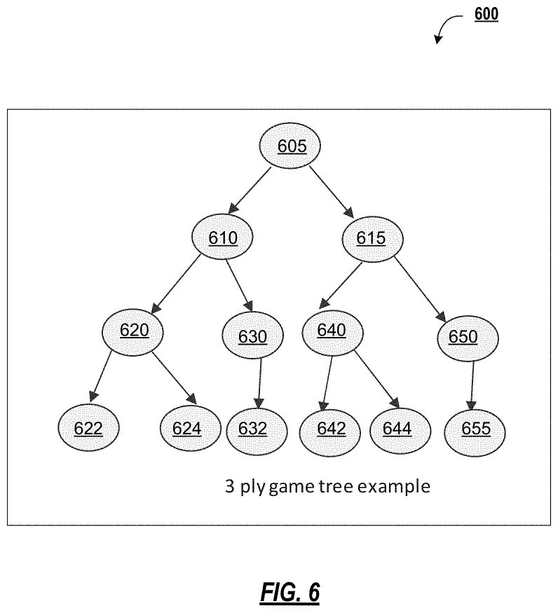

As shown in block 545, the system plays the game, via a neural network, to generate an output associated with the at least one real-time interaction request. The system plays the game to identify all possible outcomes as shown in FIG. 6 and generates the output that is associated with the at least one real-time interaction request. For example, the system may identify that a user is interacting with the IVR system to report a misappropriated credit card associated with a first account and request a new credit card. The system may map this interaction request onto the game and may identify historical event sequences associated with the first account. The system causes the neural network to play the game to identify all possible outcomes after approving and rejecting the interaction request. The neural network may then compare the outcomes, the interaction request, and the historical event sequences associated with the one or event sequences stored look-up library and generates the output. In some embodiments, the output may be a recommendation for approving or rejecting the interaction request. In some embodiments, the output may be recommendation for performing one or more steps before approving or denying the interaction request. For example, the system may generate a recommendation of performing secondary authentication before approving or denying the interaction request. The system generates the output based on balancing unauthorized user gain and authorized user denials. It is not desirable to block the authorized user and allow an unauthorized user to perform certain actions. Therefore, the system causes the trained neural network to generate a balanced output that blocks the unauthorized user and easily allows the authorized user to perform one or more actions that may be associated with a user account. The system feeds real-time data to the neural network and causes the neural network to learn and train itself. In some embodiments, the system may generate or modify the generated output based on one or more policies associated with the entity.

FIG. 6 provides a block diagram 600 illustrating a 3 play game tree example for illustrating all possible outcomes associated with event sequences, in accordance with an embodiment of the invention. The levels or tiers shown in FIG. 6 may be referred to as plies. The directed graph shown in the FIG. 6 comprises nodes, where each node represents an interaction and where each edge represents a possible outcome, in accordance with an embodiment of the present invention. For a first interaction 605, the system may identify that a next move by a user may be 610 or 615. In the case where the user performs an interaction 610, the system may identify the possible outcomes as 620 and 630. For the interaction 620, the system may identify that the next possible move may be 622 and 624. For the interaction 630, the system may identify that a possible outcome as being 632. For example, if a user calls an IVR system and requests change of account information, the system may identify that the user (e.g., imposter) may drain the resources in the account after changing the account information in the previous interaction. In the case where the user performs an interaction 615, the system may identify the possible outcomes as 640 and 650. For the interaction 640, the system may identify that next possible moves may be 642 and 644. For the interaction 650, the system may identify that a next possible move may be 655.

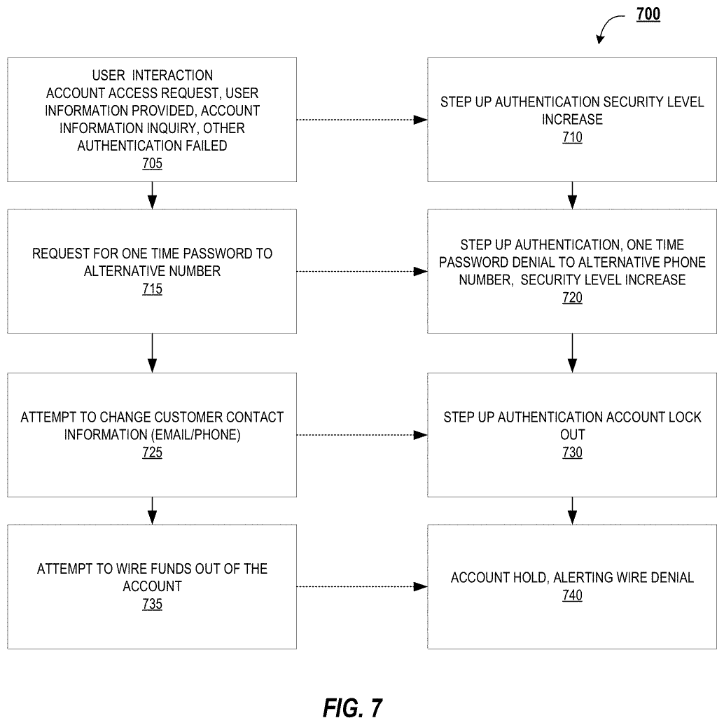

FIG. 7 provides a block diagram 700 illustrating one or more steps performed by the system to prevent misappropriation of information exchanged between the entity and the users during interactions. The event sequences described in FIG. 7 are for illustrative purposes only and there may be other event sequences that may require different steps to prevent misappropriation of information. As shown in block 705, if a user interacts with the entity system and requests permission to access an account or enquires about an account by providing part of the user information (e.g., last 4 digits of a Social Security Number), the system accesses the event sequences associated with the account to identify a failed authentication attempt and may step up authentication security level associated with the account as shown in block 710 before providing information or access rights requested by the user. Next, as shown in block 710, if a user interacts with an entity system and requests for a One Time Password (OTP) associated with authenticating the account to be sent to a different phone number, the system identifies the previous event sequence provided in block 705, steps up authentication, and denies the One Time Password request as shown in block 720. Following the interaction in block 715, if a user interacts with an entity system and attempts to change customer information such as phone number or email as shown in block 725, the system identifies the previous event sequences such as failed authentication attempts, requesting OTP to be sent to an alternative phone number, or the like as discussed in block 705 and 715 and steps up the authentication by locking the account as shown in block 730. Following the interaction in block 725, if a user interacts with the entity system to attempt to wire funds out of the account as shown in block 735, the system identifies the previous event sequences and places the account on hold and transmits one or more alerts to the account holder and an employee of the entity system as shown in block 740.

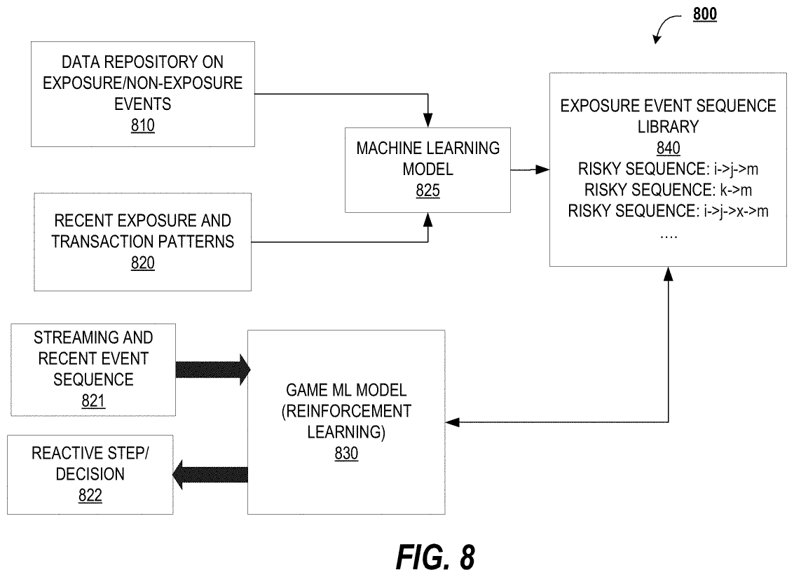

FIG. 8 provides a block diagram 800 illustrating the functions of the event sequence analysis system 300 of FIG. 1, in accordance with an embodiment of the invention. The system may input the exposure and non-exposure related data 810 and recent exposure and transaction patterns 820 into a machine learning model 825, where the machine learning model 825 creates the exposure event sequence library 840 comprising one or more risky event sequences (e.g., risky sequence: i->j->m, risky sequence: k->m, risky sequence: i->j->x->m, or the like) and/or one or more non-risky event sequences. The system then inputs the one or more event sequences into the game machine learning model 830, where the system models a game associated with the event sequences. The system causes the game machine learning model 830 to train itself using the one or more event sequences and also causes the game machine learning model 830 to prune the one or more event sequences in the exposure event sequence library 840. The system then inputs the real-time events to the game machine learning model 830 by monitoring real-time streams as shown in 821. The system may then cause the game machine learning model 830 to output a reactive step (recommendation) and/or decision (approve or deny the request associated with the interaction) as shown in block 822. In some embodiments, the system may use Minimax, Monte Carlo Tree search variant algorithm, or a hybrid of Minimax and Monte Carlo Tree Search algorithms to minimize losses during the customer interaction process. In other words, the system minimizes gains of the unauthorized users (e.g., imposters) and minimizes losses of the authentic user due to the added complexity of the uncertainty of interactions with unauthorized users or authentic customers. In some embodiments, the system prunes the one or more event sequences by using alpha-beta pruning technique to reduce the complexity. Alpha-beta pruning is an adversarial search algorithm that decreases the number of nodes that are evaluated by the minimax algorithm in its search tree.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for event detection and mitigation using game theoretical event sequence analysis, comprising:
one or more computer processors;
a memory; and
a processing module stored in the memory, executable by the one or more computer processors and configured to:
extract interaction data from one or more data sources;
analyze the interaction data to identify one or more exposure event sequences;
store the one or more exposure event sequences in look-up libraries;
model a game by mapping one or more interactions associated with the interaction data;
continuously monitor real-time interaction streams;
identify at least one real-time interaction request based on continuously monitoring the real-time interaction streams;
map the at least one real-time interaction request onto the game; and
play the game, via a neural network, to generate an output associated with the at least one real-time interaction request.

2. The system according to claim 1, wherein the processing module is further configured to model the game based on:
mapping one or more states associated with the one or more interactions;
mapping one or more state transitions associated with the one or more interactions; and
mapping one or more exposures associated with each of the one or more states.

3. The system according to claim 1, wherein the processing module is further configured to
prune the one or more exposure event sequences; and
update the look-up libraries with pruned one or more exposure event sequences.

4. The system according to claim 3, wherein the processing module is further configured to:
input the pruned one or more exposure event sequences to the neural network; and
cause the neural network to train itself via reinforcement learning, wherein the neural network trains itself based on playing the game against itself as an unauthorized user.

5. The system according to claim 3, wherein the processing module is further configured to
dynamically prune the pruned one or more exposure event sequences based on real-time interaction data that is extracted from the real-time interaction streams; and
update the look-up libraries with dynamically pruned one or more exposure event sequences, wherein the dynamically pruned one or more exposure event sequences used by the neural network to train itself.

6. The system of claim 1, wherein the processing module is further configured to play the game to generate the output by:
identifying one or more possible paths associated with the at least one real-time interaction; and
determining one or more possible outcomes for each of the one or more possible paths associated with the at least one real-time interaction.

7. The system of claim 1, wherein the processing module is further configured to generate the output based on balancing unauthorized user gain and authorized user denials.

8. The system of claim 1, wherein the processing module is further configured to generate the output based on one or more policies associated with an entity.

9. A computer program product for event detection and mitigation, comprising a non-transitory computer-readable storage medium having computer-executable instructions for:
extracting interaction data from one or more data sources;
analyzing the interaction data to identify one or more exposure event sequences;
storing the one or more exposure event sequences in look-up libraries;
modelling a game by mapping one or more interactions associated with the interaction data;
continuously monitoring real-time interaction streams;
identifying at least one real-time interaction request based on continuously monitoring the real-time interaction streams;
mapping the at least one real-time interaction request onto the game; and
playing the game, via a neural network, to generate an output associated with the at least one real-time interaction request.

10. The computer program product according to claim 9, wherein the non-transitory computer-readable storage medium comprises computer-executable instructions for modelling the game based on:
mapping one or more states associated with the one or more interactions;
mapping one or more state transitions associated with the one or more interactions; and
mapping one or more exposures associated with each of the one or more states.

11. The computer program product according to claim 9, wherein the computer-executable instructions further comprise:
pruning the one or more exposure event sequences; and
updating the look-up libraries with pruned one or more exposure event sequences.

12. The computer program product according to claim 11, wherein the computer-executable instructions further comprise:
inputting the pruned one or more exposure event sequences to the neural network; and
causing the neural network to train itself via reinforcement learning, wherein the neural network trains itself based on playing the game against itself as an unauthorized user.

13. The computer program product according to claim 11, wherein the computer-executable instructions further comprise:
dynamically pruning the pruned one or more exposure event sequences based on real-time interaction data that is extracted from the real-time interaction streams; and
updating the look-up libraries with dynamically pruned one or more exposure event sequences, wherein the dynamically pruned one or more exposure event sequences used by the neural network to train itself.

14. The computer program product according to claim 9, wherein the computer-executable instructions for playing the game to generate the output comprise:
identifying one or more possible paths associated with the at least one real-time interaction; and
determining one or more possible outcomes for each of the one or more possible paths associated with the at least one real-time interaction.

15. The computer program product according to claim 9, wherein generating the output based on balancing unauthorized user gain and authorized user denials

16. A computerized method for event detection and mitigation, comprising:
extracting interaction data from one or more data sources;
analyzing the interaction data to identify one or more exposure event sequences;
storing the one or more exposure event sequences in look-up libraries;
modelling a game by mapping one or more interactions associated with the interaction data;
continuously monitoring real-time interaction streams;
identifying at least one real-time interaction request based on continuously monitoring the real-time interaction streams;
mapping the at least one real-time interaction request onto the game; and
playing the game, via a neural network, to generate an output associated with the at least one real-time interaction request.

17. The computerized method according to claim 16, wherein the method further comprises:
pruning the one or more exposure event sequences; and
updating the look-up libraries with pruned one or more exposure event sequences.

18. The computerized method according to claim 17, wherein the method further comprises:
inputting the pruned one or more exposure event sequences to the neural network; and
causing the neural network to train itself via reinforcement learning, wherein the neural network trains itself based on playing the game against itself as an unauthorized user.

19. The computerized method according to claim 17, wherein the method further comprises:
dynamically pruning the pruned one or more exposure event sequences based on real-time interaction data that is extracted from the real-time interaction streams; and
updating the look-up libraries with dynamically pruned one or more exposure event sequences, wherein the dynamically pruned one or more exposure event sequences used by the neural network to train itself.

20. The computerized method according to claim 16, wherein generating the output based on balancing unauthorized user gain and authorized user denials.
